(19) United States
(12) Patent Application Publication
(10) Pub. No.: US 2024/0083785 A1
(43) Pub. Date: Mar. 14, 2024

(54) CONVENIENT HYDROGEN RICH WATER CUP

(71) Applicant: Shenzhen Changjiang Electric Technology Co., Ltd., Shenzhen (CN)

(72) Inventors: RUI WANG, Xiangtan (CN); Dengyou XIAO, Xiangtan (CN)

(73) Assignee: Shenzhen Changjiang Electric Technology Co., Ltd., Shenzhen (CN)

(21) Appl. No.: 18/242,440

(22) Filed: Sep. 5, 2023

(30) Foreign Application Priority Data
Sep. 8, 2022 (CN) 2022223896841

(51) Int. Cl. C02F 1/68; C02F 1/461

(52) U.S. Cl. CPC C02F 1/68; C02F 1/46109; C02F 2201/006; C02F 2201/46165; C02F 2307/04

(57) ABSTRACT

A convenient hydrogen rich water cup includes a water cup body, wherein the bottom of the water cup body is equipped with a built-in slot, wherein a wireless power socket is embedded. The water cup body is internally equipped with a hydrogen rich water generation module, which is electrically connected to the wireless power socket. This invention patent provides power to the hydrogen rich water generation module through a wireless power socket, simplifying the structure of the hydrogen rich water cup, and can adapt to the currently popular wireless charger to power it, greatly reducing its manufacturing cost and making it convenient to carry and use, which is conducive to the widespread application of the product. Moreover, using the embedded slot to fix the wireless power socket can improve the connection stability between the wireless power socket and the water cup body, making the product performance more stable and durable.

### CROSS-REFERENCE TO RELATED APPLICATIONS

The application claims priority to Chinese patent application No. 2022223896841, filed on Sep. 8, 2022, the entire contents of which are incorporated herein by reference.

### TECHNICAL FIELD

This invention patent relates to the technical field of hydrogen rich water generation equipment, in particular to a convenient hydrogen rich water cup.

### BACKGROUND

Direct current electrolysis hydrogen production (hereinafter referred to as strong electrolysis hydrogen production) technology uses precious metals such as platinum (or ruthenium iridium coating) as electrode materials, and uses direct current to conduct strong electrolysis of water to produce hydrogen.

Currently, most of the equipment used for producing hydrogen rich water through electrolysis is a complete set of equipment, which is not only bulky and inconvenient to carry, but also has high manufacturing costs, making it difficult for the equipment to be widely used.

### SUMMARY

The purpose of this invention patent is to provide a convenient hydrogen rich water cup, which is equipped with a hydrogen rich water generation module on the water cup body, and is powered by a wireless power socket to simplify the structure of the hydrogen rich water cup. Moreover, it can adapt to the currently popular wireless charging appliances to power it, greatly reducing its manufacturing cost and making it convenient to carry and use, which is conducive to the widespread application of the product, to address the issues raised in the background technology mentioned above.

In order to achieve the above objectives, the present invention patent provides the following technical solution: a convenient hydrogen rich water cup, comprising a water cup body, wherein the bottom of the water cup body is provided with an embedded slot, and the embedded slot is embedded with a wireless power socket. The water cup body is internally equipped with a hydrogen rich water generation module, which is electrically connected to the wireless power socket.

Preferably, the bottom of the embedded slot is provided with a second through hole, and the hydrogen rich water generation module is electrically connected to the wireless grounding base through the second through hole through a conductive plug component.

Preferably, the hydrogen rich water generation module includes a shell, which includes a module upper shell and a module lower shell connected to each other. A cavity is formed between the module upper shell and the module lower shell, and the cavity is provided with an anode electrolytic sheet and a cathode electrolytic sheet. A proton membrane is sandwiched between the anode electrolytic sheet and the cathode electrolytic sheet, and the anode electrolytic sheet and the cathode electrolytic sheet are separated in intervals, The conductive plug components are equipped with two pieces, which are respectively electrically connected to the anode electrolytic sheet and the cathode electrolytic sheet. The two conductive plug components are respectively electrically connected to the positive and negative poles of the output end of the wireless grounding base.

Preferably, the bottom of the hydrogen rich water generation module shell is provided with a first through hole corresponding to the conductive plug component position, and the top of the wireless power base shell is provided with a third through hole corresponding to the conductive plug component position. The conductive plug component includes a locking screw, a sealing plug, a conductive plug, a gasket, a spring washer, and a locking nut. The sealing plug is placed inside the first through hole, and the conductive plugs run through the first through hole from top to bottom The second through hole and the third through hole are arranged, and the locking screw is tightly connected to the conductive bolt above the first through hole. The gasket, spring washer, and locking nut are sequentially sleeved on the circumference of the conductive bolt on the inner side of the wireless grounding base housing, and the locking nut is tightly connected to the conductive bolt thread.

Preferably, the wireless grounding base comprises an upper shell of the grounding base and a lower shell of the grounding base that are covered and connected to each other. A cavity is formed between the upper shell of the grounding base and the lower shell of the grounding base, and the cavity is provided with a circuit board component and a wireless receiving coil. The conductive plug component and the wireless receiving coil are both electrically connected to the circuit board component.

Preferably, a waterproof sealing ring is sandwiched between the connecting surface of the upper shell of the power socket and the lower shell of the power socket.

Preferably, the anode electrolytic sheet and cathode electrolytic sheet are circumferentially sheathed with silicone sleeves.

Preferably, the embedded slot position is connected to the external part of the water cup body, and the circumferential contour of the wireless power supply seat matches the circumferential contour of the embedded slot position.

Preferably, the embedded slot is arranged in communication with the exterior of the water cup body, and the bottom surface of the wireless power socket is level with the bottom surface of the water cup body.

Compared with the prior art, the invention patent has the following beneficial effects:

This invention patent is equipped with a hydrogen rich water generation module on the water cup body, and supplies power to the hydrogen rich water generation module through a wireless power socket, simplifying the structure of the hydrogen rich water cup and adapting to the current popular wireless charger to power it, greatly reducing its manufacturing cost and making it convenient to carry and use, which is conducive to the widespread application of the product; The wireless power socket is combined with the water cup body by embedding a slot below the water cup body, which is not only conducive to the integrated industrial appearance design of the product, but also improves the overall feeling and aesthetics of the product. Moreover, using the embedded slot to fix the wireless power socket can effectively improve the connection stability between the wireless power socket and the water cup body, making the product performance more stable and durable.

### BRIEF DESCRIPTION OF DRAWINGS

FIG. 1 is a schematic diagram of the structure of the present invention patent;

FIG. 2 is an exploded view of the hydrogen rich water generation module and wireless power socket structure of the invention patent;

FIG. 3 is a schematic diagram of the connection relationship between the hydrogen rich water generation module and the wireless power socket of the invention patent;

FIG. 4 is the structural schematic diagram II of the present invention patent;

FIG. 5 is the structural schematic diagram III of the present invention patent.

In the picture: 1. The water cup body; 11 embedded slots; 12 second through-hole; 2 hydrogen rich water generation module; 21 module upper shell; 22 silicone sleeve; 23 anode electrolytic sheets; 24 proton membrane; 25 cathode electrolytic sheets; 26 module lower shell; 261 first through-hole; 3 conductive plug components; 31 locking screws; 32 sealing plugs; 33 conductive plugs; 34 gaskets; 35 spring washer; 36 locking nut; 4 wireless power sockets; 41 Upper shell of the power socket; 411 third through-hole; 42 waterproof sealing ring; 43 circuit board components; 44 wireless receiving coil; Connect the lower shell of the 45 electrical socket.

### DETAILED DESCRIPTION OF THE EMBODIMENTS

The following will provide a clear and complete description of the technical solution in the embodiments of this invention patent, in conjunction with the accompanying drawings. Obviously, the described embodiments are only a part of the embodiments of this invention patent, not all of them. Based on the embodiments in this invention patent, all other embodiments obtained by ordinary technical personnel in this field without creative labor fall within the scope of protection of this invention patent.

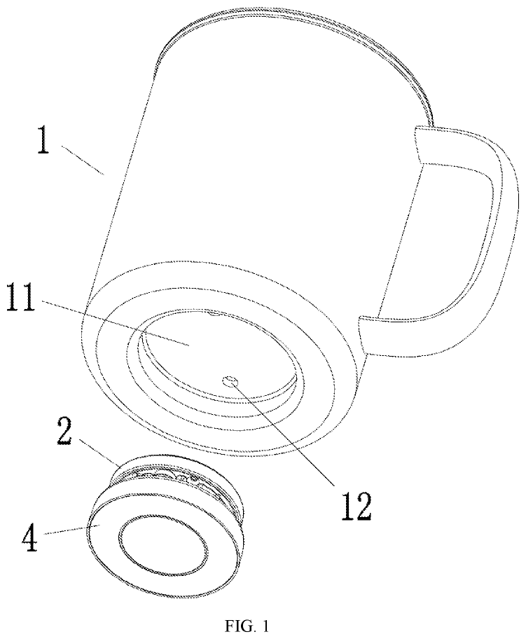

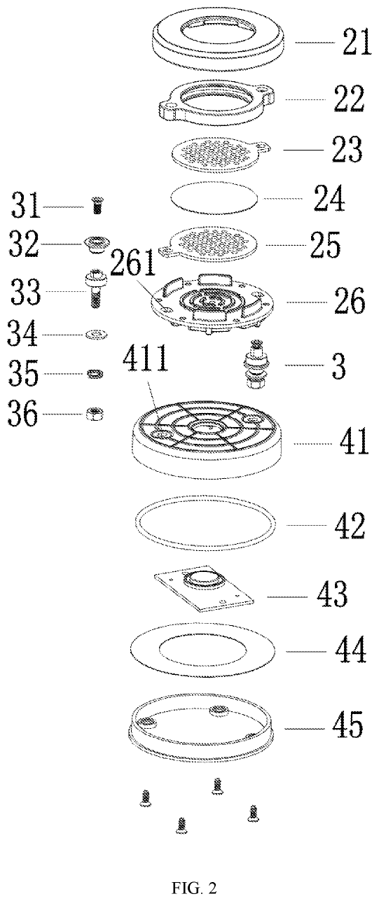

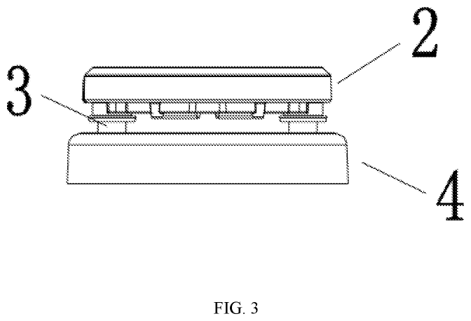

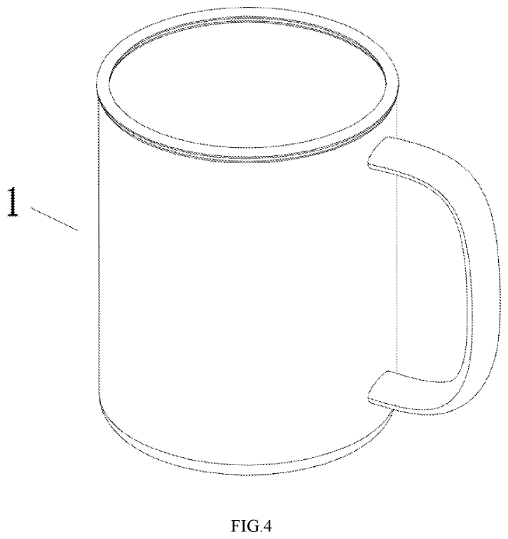

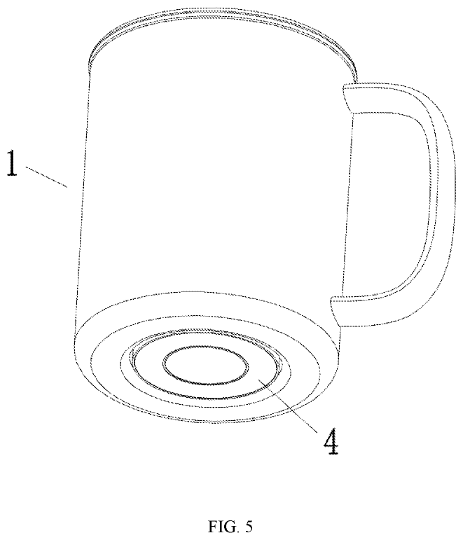

Please refer to FIGS. 1-5. In the embodiment of this invention patent, a convenient hydrogen rich water cup includes a water cup body 1, wherein the bottom of the water cup body 1 is provided with an embedded slot 11, which is externally connected to the water cup body 1. The circumferential contour of the wireless power socket 4 matches the circumferential contour of the embedded slot 11, and the bottom surface of the wireless power socket 4 is set flush with the bottom surface of the water cup body 1, The embedded slot 11 is embedded with a wireless power socket 4, and the water cup body 1 is internally equipped with a hydrogen rich water generation module 2. The bottom of the embedded slot 11 is provided with a second through-hole 12, and the hydrogen rich water generation module 2 is electrically connected to the wireless power socket 4 through the second through-hole 12 using a conductive plug component 3

The hydrogen rich water generation module 2 includes a shell, which includes a module upper shell 21 and a module lower shell 26 that are mutually covered and connected. A cavity is formed between the module upper shell 21 and the module lower shell 26, and the cavity is provided with an anode electrolytic sheet 23 and a cathode electrolytic sheet 25. The anode electrolytic sheet 23 and the cathode electrolytic sheet 25 are preferably made of titanium alloy or platinum alloy sheets, A proton membrane 24 is sandwiched between the anode electrolytic sheet 23 and the cathode electrolytic sheet 25. The anode electrolytic sheet 23 and the cathode electrolytic sheet 25 are separated and arranged in intervals. The anode electrolytic sheet 23 and the cathode electrolytic sheet 25 are surrounded by a silicone sleeve 22, which is used to protect and stabilize the connection structure between the anode electrolytic sheet 23 and the cathode electrolytic sheet 25. The conductive plug assembly 3 is equipped with two pieces, The two conductive plug assemblies 3 are electrically connected to the anode electrolytic sheet 23 and the cathode electrolytic sheet 25, respectively, and the two conductive plug assemblies 3 are electrically connected to the positive and negative poles of the output terminals of the wireless grounding base 4.

The bottom of the shell of the hydrogen rich water generation module 2 corresponds to a first through hole 261 at the position of the conductive plug component 3, and the top of the wireless power supply base 4 corresponds to a third through hole 411 at the position of the conductive plug component 3. The conductive plug component 3 includes a locking screw 31, a sealing plug 32, a conductive plug 33, a gasket 34, a spring washer 35, and a locking nut 36. The sealing plug 32 is arranged in the first through hole 261, The conductive plug 33 runs through the first through-hole 261, the second through-hole 12, and the third through-hole 411 from top to bottom. The locking screw 31 is tightly connected to the conductive plug 33 above the first through-hole 261, and the gasket 34, spring washer 35, and locking nut 36 are sequentially sleeved on the circumference of the conductive plug 33 inside the housing of the wireless connection base 4. The locking nut 36 is securely connected to the conductive plug 33 in a threaded manner.

The wireless grounding base 4 includes an upper shell 41 and a lower shell 45 of the grounding base that are mutually covered and connected. A waterproof sealing ring 42 is sandwiched between the connecting surface of the upper shell 41 of the grounding base and the lower shell 45 of the grounding base. A cavity is formed between the upper shell 41 of the grounding base and the lower shell 45 of the grounding base. The cavity is equipped with a circuit board component 43 and a wireless receiving coil 44, and both the conductive plug component 3 and the wireless receiving coil 44 are electrically connected to the circuit board component 43.

In summary, this invention patent is equipped with a hydrogen rich water generation module 2 on the water cup body 1, and supplies power to the hydrogen rich water generation module 2 through a wireless power socket 4, simplifying the structure of the hydrogen rich water cup and adapting to the currently popular wireless charger for power supply, greatly reducing its manufacturing cost and making it convenient to carry and use, which is conducive to the widespread application of the product; The wireless power socket 4 is combined with the water cup body 1 by embedding a slot 11 under the water cup body 1, which is not only conducive to the integrated industrial appearance design of the product, but also improves the overall feeling and aesthetics of the product. Moreover, using the embedded slot 11 to fix the wireless power socket 4 can effectively improve the connection stability between the wireless power socket 4 and the water cup body 1, making the product's performance more stable and durable.

For those skilled in the art, it is evident that the present invention patent is not limited to the details of the exemplary embodiments mentioned above, and can be implemented in other specific forms without departing from the spirit or basic features of the present invention patent. Therefore, from any perspective, the embodiments should be regarded as exemplary and nonrestrictive. The scope of this invention patent is limited by the accompanying claims rather than the above description. Therefore, the aim is to include all changes within the meaning and scope of the equivalent elements of the claims within this invention patent. Any accompanying drawings in the claims should not be regarded as limiting the claims involved.

What is claimed is:

1. A convenient hydrogen rich water cup, comprising a water cup body (1), characterized in that: the bottom of the water cup body (1) is equipped with an embedded slot (11), and the embedded slot (11) is embedded with a wireless power socket (4); the water cup body (1) is internally equipped with a hydrogen rich water generation module (2), which is electrically connected to the wireless power socket (4).

2. A convenient hydrogen rich water cup according to claim 1, characterized in that a second through hole (12) is opened at the bottom of the embedded slot (11), and the hydrogen rich water generation module (2) is electrically connected to the wireless grounding base (4) through the second through hole (12) using a conductive plug component (3).

3. A convenient hydrogen rich water cup according to claim 2, characterized in that the hydrogen rich water generation module (2) comprises a shell, wherein the shell comprises a module upper shell (21) and a module lower shell (26) connected to each other, and a cavity is formed between the module upper shell (21) and the module lower shell (26); the cavity is provided with an anode electrolytic sheet (23) and a cathode electrolytic sheet (25), A proton membrane (24) is sandwiched between the anode electrolytic sheet (23) and the cathode electrolytic sheet (25), and the anode electrolytic sheet (23) is separated from the cathode electrolytic sheet (25) at intervals; the conductive plug assembly (3) is provided with two pieces, which are electrically connected to the anode electrolytic sheet (23) and the cathode electrolytic sheet (25), respectively, The two conductive plug components (3) are respectively electrically connected to the positive and negative poles of the output terminals of the wireless grounding base (4).

4. A convenient hydrogen rich water cup according to claim 2, characterized in that: the hydrogen rich water generation module (2) is provided with a first through hole (261) at the bottom of the shell corresponding to the conductive plug component (3), and the wireless grounding base (4) is provided with a third through hole (411) at the top of the shell corresponding to the conductive plug component (3); the conductive plug component (3) includes a locking screw (31), a sealing plug (32), and a conductive plug (33) A gasket (34), a spring washer (35), and a locking nut (36), wherein the seal (32) is arranged in the first through-hole (261), the conductive plug (33) runs through the first through-hole (261), the second through-hole (12), and the third through-hole (411) from top to bottom, and the locking screw (31) is tightly connected to the conductive plug (33) above the first through-hole (261); the gasket (34) The spring pad (35) and lock nut (36) are located on the inner side of the housing of the wireless grounding base (4), and are sequentially sleeved on the circumference of the conductive plug (33); the lock nut (36) is tightly connected to the conductive plug (33) in a threaded manner.

5. A convenient hydrogen rich water cup according to claim 2, characterized in that the wireless power supply base (4) comprises an upper shell (41) of the power supply base and a lower shell (45) of the power supply base, which are mutually covered and connected; a capacitance cavity is formed between the upper shell (41) of the power supply base and the lower shell (45) of the power supply base, and the capacitance cavity is provided with a circuit board component (43) and a wireless receiving coil (44), The conductive plug assembly (3) and the wireless receiving coil (44) are electrically connected to the circuit board assembly (43).

6. A convenient hydrogen rich water cup according to claim 5, characterized in that a waterproof sealing ring (42) is sandwiched between the connecting surface of the upper shell (41) of the power supply seat and the lower shell (45) of the power supply seat.

7. A convenient hydrogen rich water cup according to claim 3, characterized in that the anode electrolytic sheet (23) and cathode electrolytic sheet (25) are circumferentially sheathed with a silicone sleeve (22).

8. A convenient hydrogen rich water cup according to claim 1, characterized in that the embedded slot (11) is externally connected to the water cup body (1), and the circumferential contour of the wireless power socket (4) matches the circumferential contour of the embedded slot (11).

9. A convenient hydrogen rich water cup according to claim 1, characterized in that the embedded slot (11) is externally connected to the water cup body (1), and the bottom surface of the wireless power socket (4) is level with the bottom surface of the water cup body (1).
